(19) United States
(12) Patent Application Publication
(10) Pub. No.: US 2026/0084050 A1
(43) Pub. Date: Mar. 26, 2026

(54) STORAGE MEDIUM, INFORMATION PROCESSING SYSTEM, AND GAME PROCESSING METHOD

(71) Applicant: NINTENDO CO., LTD., Kyoto (JP)

(72) Inventors: Shigekazu YAMADA, Tokyo (JP); Daisuke YOSHINAGA, Tokyo (JP)

(21) Appl. No.: 19/327,054

(22) Filed: Sep. 12, 2025

(30) Foreign Application Priority Data
Sep. 20, 2024 (JP) 2024-163895

(51) Int. Cl. A63F 13/52

(52) U.S. Cl. CPC A63F 13/52

(57) ABSTRACT

An example of an information processing system, in a battle scene in a game, in a case where any of commands of a plurality of types is specified by a first instruction, and a state of the specified command is in a usable state, causes a player character to perform a behavior associated with the command, causes the command to transition to an unusable state, and resets a first parameter associated with the command. In a case where the command in the unusable state is specified by a second instruction, and a second parameter can be consumed, the information processing system consumes the second parameter, causes the player character to perform the behavior associated with the command, sets the command to the unusable state, and resets the first parameter associated with the command.

### CROSS REFERENCE TO RELATED APPLICATION

This application claims priority to Japanese Patent Application No. 2024-163895, filed on Sep. 20, 2024, the entire contents of which are incorporated herein by reference.

### FIELD

The present disclosure relates to a storage medium, an information processing system, and a game processing method for executing a game where a player character and an enemy character battle against each other.

### BACKGROUND AND SUMMARY

Conventionally, there is a game where in a battle scene between a player character and an enemy character, the player character is caused to perform a behavior corresponding to a command specified by a player.

Depending on the type of a command, for example, it is necessary to satisfy a condition such as the lapse of a certain time from when the command is specified to when the same command can be specified next. Regarding a command of such a type, there is a case where the condition is not satisfied after the command is previously specified, and therefore, the command cannot be specified at a timing desired by the player during the game.

Therefore, the present application provides a storage medium, an information processing system, and a game processing method in which a player can specify a command that does not satisfy a condition under a certain condition.
(1)

An example of one or more non-transitory computer-readable medium stores therein instructions that, when executed, cause one or more processors of an information processing apparatus to execute information processing comprising: in a battle scene between a player character and an enemy character in a game, in a case where any of commands of a plurality of types is specified by a first instruction based on an operation input, and a state of the specified command is a usable state between the usable state and an unusable state, causing the player character to perform a behavior associated with the command; causing the specified command to transition to the unusable state; and resetting a first parameter associated with the specified command among first parameters set for the respective commands; in a case where the first parameter satisfies a first condition, causing the command associated with the first parameter to transition to the usable state, wherein the first parameter regarding each of the commands in the unusable state is updated in accordance with progress of a game; and in a case where the command in the unusable state is specified by a second instruction based on an operation input, and a second parameter can be consumed; consuming the second parameter; causing the player character to perform the behavior associated with the command; setting the specified command to the unusable state; and resetting the first parameter associated with the specified command.

According to the above configuration (1), in a game where a condition for using a command again is set, a player can also specify a command that does not satisfy the condition under a certain condition.
(2)

In the configuration of the above (1), the information processing may comprise updating the first parameter regarding each of the commands in the unusable state in accordance with a lapse of time as the progress of the game.

According to the above configuration (2), in a case where a second parameter can be consumed, the player can use a command without waiting for the lapse of time.
(3)

In the configuration of the above (2), the first condition may be satisfied by a lapse of time having a length set with respect to each of the commands since the first parameter is reset.

According to the above configuration (3), it is possible to set the time until a first parameter satisfies a first condition with respect to each command.
(4)

In the configuration of any one of above (1) to (3), the information processing may comprise in a case where the command in the unusable state is specified by the second instruction, and the second parameter that remains is greater than or equal to a decrease amount corresponding to a shortfall until the first parameter regarding the specified command at this time satisfies the first condition, decreasing the second parameter by the decrease amount, thereby consuming the second parameter.

According to the above configuration (4), it is possible to enable a command to be used by causing a second parameter having an amount corresponding to the shortfall of a first parameter to be consumed.
(5)

In the configuration of any one of above (1) to (4), the information processing may comprise recovering the second parameter after the battle scene ends.

According to the above configuration (5), it is possible to make it easy to consume a second parameter with respect to each battle scene.
(6)

In the configuration of the above (5), during the battle scene, the second parameter may be prohibited from being recovered.

According to the above configuration (6), it is possible to set a restriction on the consumption of the second parameter in a single battle scene. Thus, in an easy battle scene such as a battle with a weak enemy character, it is possible to quickly advance a battle, and in a tough battle scene such as a battle with a strong enemy character, a battle does not become too easy, and it is possible to provide a strategic battle.
(7)

In the configuration of any one of above (1) to (6), the second parameter may be prohibited from being recovered during the battle scene. The information processing may comprise: recovering the second parameter to an upper limit value after the battle scene ends; and increasing the upper limit value of the second parameter in a first scene in the game.

According to the above configuration (7), the player is given the opportunity to increase the upper limit value of a second parameter, whereby it is possible to motivate the player to advance the game.
(8)

In the configuration of any one of above (1) to (7), the information processing may further comprise displaying an icon indicating, with respect to each of the commands, whether the command is in the usable state or the unusable state, and the first parameter in the unusable state, and a gauge indicating the second parameter.

According to the above configuration (8), the player can confirm the state of a command, and with reference to the current value of a second parameter, can also determine whether or not to use the command in an unusable state based on the consumption of the second parameter.
(9)

In the configuration of the above (8), the first instruction may be an instruction to select the command based on a direction input and determine a command that is being selected in accordance with a first button input, thereby specifying the determined command. The second instruction may be an instruction to select the command based on the direction input and determine a command that is being selected in accordance with a second button input, thereby specifying the determined command. The information processing may comprise, with respect to each of the commands that are being selected, displaying an indicator indicating whether or not the second parameter can be consumed regarding the command.

According to the above configuration (9), it is possible to present to the player whether or not a command in the unusable state can be used based on the consumption of the second parameter.
(10)

In the configuration of any one of above (1) to (9), during a period in which a second condition regarding a situation of a battle is satisfied, an effect of the behavior corresponding to the first command among the commands of the plurality of types may be greater than during a period in which the second condition is not satisfied.

According to the above configuration (10), the situation where a particular command is effective in the game during a particular period occurs, and it is possible to make it easy to use a command in such a situation.

The present specification discloses an example of an information processing apparatus or an information processing system that executes the processing in the above (1) to (10). The present specification also discloses an example of a game processing method for causing an information processing system to execute the processing in the above (1) to (10).

According to the above storage medium, the above information processing system, the above game processing method, or the above information processing apparatus, a player can also specify a command that does not satisfy a condition under a certain condition.

These and other features, aspects, and advantages of the subject matter described herein will become more apparent from the following detailed description when taken in conjunction with the accompanying drawings.

### BRIEF DESCRIPTION OF THE DRAWINGS

FIG. 1 is a diagram showing an example of an example non-limiting game system;

FIG. 2 is a block diagram showing an example of the internal configuration of an example non-limiting main body apparatus;

FIG. 3 is a diagram showing an example of a game image in a battle scene executed by the example non-limiting game system;

FIG. 4 is a diagram showing examples of changes in the appearance of a behavior command icon;

FIG. 5 is a diagram showing an example of a game image in the situation where a command can be used based on the consumption of a recasting parameter;

FIG. 6 is a diagram showing an example of a game image in the situation where a command cannot be used based on the consumption of the recasting parameter;

FIG. 7 is a diagram showing an example of a game image in the situation where an enemy character is down;

FIG. 8 is a diagram showing an example of a game image in the situation where a message from a company character is displayed;

FIG. 9 is a diagram showing examples of various pieces of data used for information processing in the example non-limiting game system;

FIG. 10 is a flow chart showing an example of the flow of a battle scene process executed by the example non-limiting game system;

FIG. 11 is a sub-flow chart showing an example of the detailed flow of a command control process in step S2 shown in FIG. 10; and

FIG. 12 is a sub-flow chart showing an example of the detailed flow of the command control process in step S2 shown in FIG. 10.

### DETAILED DESCRIPTION OF NON-LIMITING EXAMPLE EMBODIMENTS

### 1. Game System Configuration

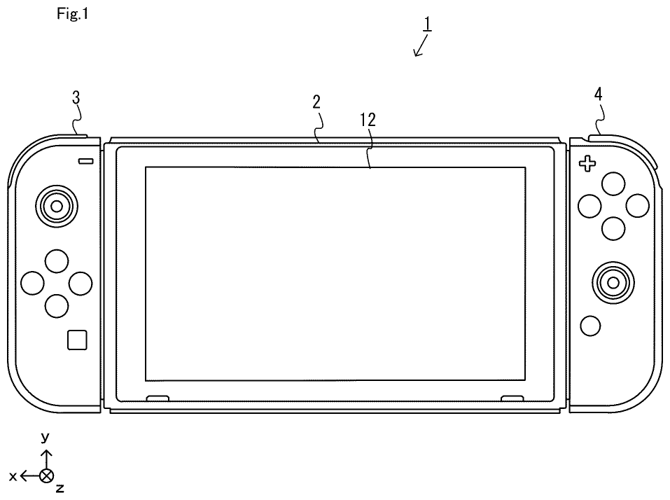

A game system according to an example of an exemplary embodiment is described below. FIG. 1 is a diagram showing an exemplary game system. An example of a game system 1 according to an exemplary embodiment includes a main body apparatus (an information processing apparatus; which functions as a game apparatus main body in an exemplary embodiment) 2, a left controller 3, and a right controller 4. The main body apparatus 2 is an apparatus for performing various processes (e.g., game processing) in the game system 1. The left controller 3 and the right controller 4 each include a plurality of buttons and an analog stick, as exemplary operation units through which a user performs input.

Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2, or the main body apparatus 2, the left controller 3, and the right controller 4 may be separated from one another, when being used. It should be noted that hereinafter, the left controller 3 and the right controller 4 will occasionally be referred to collectively as a “controller”.

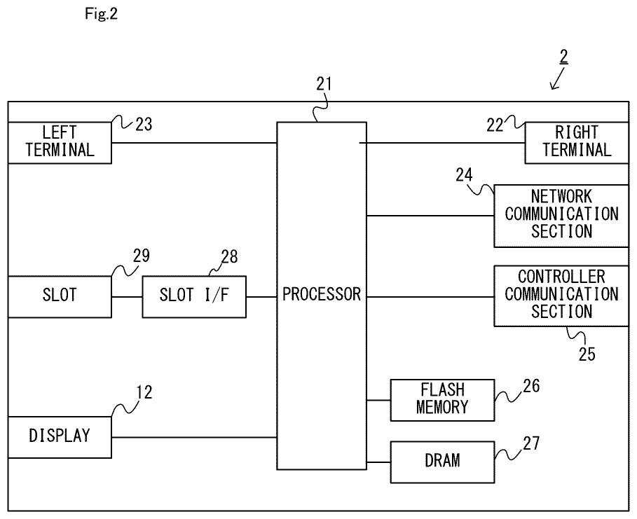

FIG. 2 is a block diagram showing an example of the internal configuration of the main body apparatus 2. As shown in FIG. 2, the main body apparatus 2 includes a processor 21. The processor 21 is an information processing section for executing various types of information processing (e.g., game processing) to be executed by the main body apparatus 2, and for example, includes a CPU (Central Processing Unit) and a GPU (Graphics Processing Unit). Note that a processor 21 may be configured only by a CPU, or may be configured by a SoC (System-on-a-Chip) that includes a plurality of functions such as a CPU function and a GPU function. The processor 21 executes an information processing program (e.g., a game program) stored in a storage section (specifically, an internal storage medium such as a flash memory 26, an external storage medium attached to the slot 29, or the like), thereby performing the various types of information processing.

Further, the main body apparatus 2 also includes a display 12. The display 12 displays an image generated by the main body apparatus 2. In an exemplary embodiment, the display 12 is a liquid crystal display device (LCD). The display 12, however, may be a display device of any type. The display 12 is connected to the processor 21. The processor 21 displays a generated image (e.g., an image generated by executing the above information processing) and/or an externally acquired image on the display 12.

Further, the main body apparatus 2 includes a left terminal 23, which is a terminal for the main body apparatus 2 to perform wired communication with the left controller 3, and a right terminal 22, which is a terminal for the main body apparatus 2 to perform wired communication with the right controller 4.

Further, the main body apparatus 2 includes a flash memory 26 and a DRAM (Dynamic Random Access Memory) 27 as examples of internal storage media built into the main body apparatus 2. The flash memory 26 and the DRAM 27 are connected to the processor 21. The flash memory 26 is a memory mainly used to store various data (or programs) to be saved in the main body apparatus 2. The DRAM 27 is a memory used to temporarily store various data used for information processing.

The main body apparatus 2 includes a slot 29. The slot 29 is so shaped as to allow a predetermined type of storage medium to be attached to the slot 29. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of a game application or the like) used by the main body apparatus 2 and/or a program (e.g., a game program or the like) executed by the main body apparatus 2.

The main body apparatus 2 includes a slot interface (hereinafter abbreviated as “I/F”) 28. The slot I/F 28 is connected to the processor 21. The slot I/F 28 is connected to the slot 29, and in accordance with an instruction from the processor 21, reads and writes data from and to the predetermined type of storage medium (e.g., a dedicated memory card) attached to the slot 29.

The processor 21 appropriately reads and writes data from and to the flash memory 26, the DRAM 27, and each of the above storage media, thereby performing the above information processing.

The main body apparatus 2 includes a network communication section 24. The network communication section 24 is connected to the processor 21. The network communication section 24 performs wired or wireless communication with an external apparatus via a network. In an exemplary embodiment, as a first communication form, the network communication section 24 connects to a wireless LAN and communicates with an external apparatus, using a method compliant with the Wi-Fi standard. Further, as a second communication form, the network communication section 24 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 communicate with each other directly or indirectly via an access point to transmit and receive data.

The main body apparatus 2 includes a controller communication section 25. The controller communication section 25 is connected to the processor 21. The controller communication section 25 wirelessly communicates with the left controller 3 and/or the right controller 4 detached from the main body apparatus 2. The communication method between the main body apparatus 2 and the left controller 3 and the right controller 4 is optional. In the exemplary embodiment, the controller communication section 25 performs communication compliant with the Bluetooth (registered trademark) standard with the left controller 3 and with the right controller 4.

The processor 21 is connected to the left terminal 23 and the right terminal 22. When performing wired communication with the left controller 3, a processor 21 transmits data to the left controller 3 via the left terminal 23 and also receives operation data from the left controller 3 via the left terminal 23. Further, when performing wired communication with the right controller 4, a processor 21 transmits data to the right controller 4 via the right terminal 22 and also receives operation data from the right controller 4 via the right terminal 22. As described above, in the exemplary embodiment, the main body apparatus 2 can perform both wired communication and wireless communication with each of the left controller 3 and the right controller 4.

It should be noted that, in addition to the elements shown in FIG. 2, the main body apparatus 2 includes a battery that supplies power and an output terminal for outputting images and audio to a display device (e.g., a television) separate from the display 12.

### 2. Overview of Processing in Game System

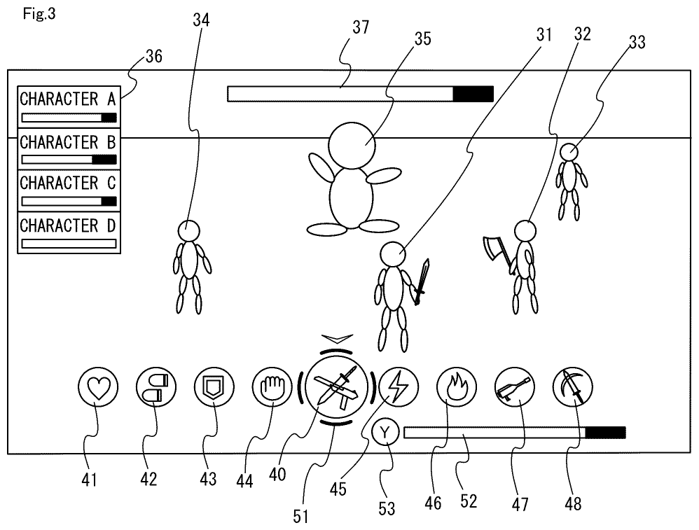

Next, with reference to FIGS. 3 to 8, an overview of game processing executed by the game system 1 is described. In the exemplary embodiment, the game system 1 executes a game including a battle scene where a player character that can be operated by a player (or a user) battles against an enemy character.

FIG. 3 is a diagram showing an example of a game image of a battle scene executed by the game system 1. As shown in FIG. 3, in the exemplary embodiment, a player character 31 and an enemy character 35 appear in a virtual game space. In the exemplary embodiment, company characters 32 to 34 that are the company of the player character 31 appear in the battle scene. In another exemplary embodiment, the company characters 32 to 34 may not appear.

The player operates the player character 31 by providing an operation input to the controller. For example, in the game space, the player character moves in a direction specified by an operation on the analog stick of the left controller 3. The player character takes on a behavior associated with a command specified by the player providing an operation input. For example, a command causes the player character 31 to take on a behavior such as an attack on the enemy character 35 or a recovery of the player character 31 itself or each of the company characters 32 to 34.

In the exemplary embodiment, in addition to the attack based on the above command, the player character 31 automatically makes an attack (hereinafter referred to as a “normal attack”) on the enemy character 35. For example, in a case where the enemy character 35 is located within the attack range of the player character 31, the game system 1 controls the player character 31 to make the normal attack on the enemy character 35 at predetermined time intervals independently of an instruction given by the player. In another exemplary embodiment, the game system 1 may cause the player character 31 to make the normal attack in accordance with an operation input provided by the player for giving an instruction to make the normal attack. Behaviors that can be taken on by the player character 31 may or may not include a behavior automatically controlled by the game system 1.

In the exemplary embodiment, the behaviors of the company characters 32 to 34 and the enemy character 35 are automatically controlled by the game system 1. For example, each of the company characters 32 to 34 takes on behaviors such as a movement in the game space, an attack on the enemy character 35, and a recovery of the player character 31, the company character itself, or another company character. The enemy character 35 takes on behaviors such as a movement in the game space and an attack on the player character 31 or each of the company characters 32 to 34. In the battle scene, the number of enemy characters is optional, and a plurality of enemy characters may appear. In another exemplary embodiment, the company characters 32 to 34 can also be operated by the player. For example, in the battle scene, a character as an operation target of the player may be switched from the character 31 to any of the other characters 32 to 34 in accordance with a predetermined operation input provided by the player.

Based on the above, in the battle scene according to the exemplary embodiment, while a battle advances by the characters 32 to 35 automatically behaving, the battle is advanced in real time by the player performing an operation on the player character 31.

As shown in FIG. 3, the game image representing the battle scene includes UI images regarding game operations in the battle scene in addition to an image representing the game space where the characters appear. In the example shown in FIG. 3, the game image includes a player character-related image 36 and an enemy character-related image 37 as UI images. The player character-related image 36 indicates the states regarding the player character 31 and the company characters 32 to 34. For example, the player character-related image 36 includes gauges indicating the hit points of the characters 31 to 34, images indicating the current states of the characters 31 to 34, and the like. The enemy character-related image 37 indicates the state regarding the enemy character 35. For example, the enemy character-related image 37 includes a gauge indicating the hit point of the enemy character 35, an image indicating the current state of the enemy character 35, and the like.

In the example shown in FIG. 3, the game image includes command icons 40 to 48 and a cursor 51 as UI images. Each of the command icons 40 to 48 indicates a command in the game. In the exemplary embodiment, the game system 1 moves the cursor 51 in accordance with a selection input to the controller and sets a command icon pointed at by the cursor 51 as a command icon that is being selected. In the example shown in FIG. 3, the command icons 40 to 48 are arranged next to each other in a left-right direction, and the cursor 51 is controlled so that the command icon pointed at by the cursor 51 switches one by one to the left and right in accordance with a selection input. The above selection input may be provided by direction inputs to a button corresponding to the movement of the cursor 51 in a predetermined forward direction and a button corresponding to the movement of the cursor 51 in a predetermined backward direction, or may be provided by providing a direction input to the analog stick of the controller. In a case where a predetermined first determination input is provided to the controller, the game system 1 sets a command icon that is being selected at the time when the first determination input is provided, as a command icon specified by the player. For example, the first determination input may be an input to a predetermined button of the controller. Based on the above, the player can specify a command indicated by a specified command icon by an instruction to specify one of the command icons 40 to 48 by the above direction inputs and the above button input to the controller.

The start command icon 40 indicates a command to start a battle. In the exemplary embodiment, in a case where the start command icon 40 is specified in the state where the player character 31 is close to an enemy character in the game space, the battle scene between the player character 31 and the enemy character is started. A condition for starting the battle scene is optional. The battle scene may be started under a condition other than the above. For example, the battle scene may be started in accordance with the player character 31 coming into contact with an enemy character. The battle scene may be started in accordance with the progress of a story in the game.

Each of the behavior command icons 41 to 48 indicates a command associated with a behavior that can be taken on by the player character 31 in the battle scene. In a case where a behavior command icon is specified in the battle scene, the game system 1 controls the player character 31 to take on the behavior associated with the command indicated by the specified behavior command icon. The specific content of the behavior associated with the command is optional. For example, the above behavior is the behavior of making an attack different from the above normal attack on an enemy character or weakening the enemy character, the behavior of recovering or strengthening the player character 31 itself or each of the company characters 32 to 34, or the like. Although in the example shown in FIG. 3, the eight behavior command icons 41 to 48 are displayed and eight types of behaviors can be taken on by the player character 31 based on the behavior command icons, the number of behavior command icons is optional. For example, the number of behavior command icons may increase in accordance with the progress of the game. For example, the player may be allowed to set the types of behavior command icons to be displayed in the battle scene. For example, before the battle scene, a predetermined number of behavior command icons may be selected by the player from among a plurality of candidates for behavior command icons, and in the battle scene, the selected behavior command icons may be displayed.

In the exemplary embodiment, a command can enter a usable state where the command can be used (or specified) and an unusable state where the command cannot be used. With respect to each command, the game system 1 manages whether the command is in the usable state or the unusable state. In a case where the command is in the usable state, the player character 31 is controlled to take on the behavior associated with the command in accordance with the specifying of the command. At this time, the game system 1 causes the command to transition to the unusable state. On the other hand, in a case where a command is in the unusable state, the game system 1 does not receive the specifying of the command by the above first determination input. That is, in the above case, even if the first determination input is provided in the state where a behavior command icon indicating the command is being selected, the player character 31 does not take on the behavior associated with the command.

In a case where a command is in the unusable state, the game system 1 updates a command parameter regarding the command in accordance with the progress of the game. In the exemplary embodiment, the command parameter indicates the time elapsed since the command enters the unusable state. The command parameter is reset at the time when the command enters the unusable state (specifically, set to 0), and increases in accordance with the lapse of time. In a case where a command parameter regarding a command reaches a predetermined recovery time, the game system 1 causes the command to transition to the usable state. The above recovery time may be set with respect to each command, and may be set to a different value with respect to each command. For example, the greater the effect of the behavior in the game associated with the command is as in a command associated with a powerful attack action, the longer the recovery time may be set to be.

A command parameter may indicate the remaining time until the command enters the usable state next. At this time, the command parameter is reset to the value of the above recovery time at the time when the command enters the unusable state, and is updated by subtracting a value from the command parameter in accordance with the lapse of time. As shown in the above example and the exemplary embodiment, a command parameter may be updated in accordance with the lapse of time as the progress of the game. A condition for a command to enter the usable state may be a condition that is satisfied by the lapse of time since the command enters the unusable state.

A command parameter is not limited to a parameter regarding the time elapsed since the command enters the unusable state as described above. For example, a command parameter may be a parameter that is updated every time the player character 31 makes the above normal attack in the battle scene. At this time, the command parameter may be reset to 0 at the time when the command enters the unusable state, and may be increased every time the normal attack is made. In a case where the command parameter reaches a predetermined value, the command may enter the usable state. For example, the command parameter may be reset to a predetermined value at the time when the command enters the unusable state, and may be decreased every time the normal attack is made. In a case where the command parameter reaches 0, the command may enter the usable state. For example, in a case where a so-called turn-based battle is performed, a command parameter may be a parameter that is updated in accordance with the passage of turns.

As described above, a command parameter may be any parameter that is updated in accordance with the progress of the game to come close to a value satisfying a condition for setting the command to the usable state.

As described above, in the exemplary embodiment, a specified command is set to the unusable state once, whereby it is possible to prevent the player from continuously specifying the same command. Consequently, for example, it is possible to reduce the possibility that the level of difficulty of a battle becomes too low by continuously specifying a powerful command. Thus, it is possible to improve the level of strategy of the game.

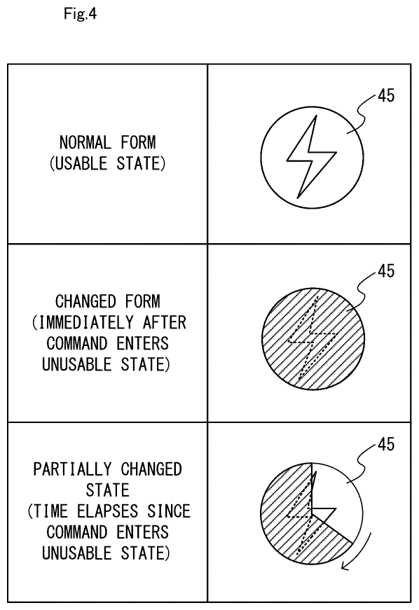

In the exemplary embodiment, the appearance of a behavior command icon changes to indicate the state of the command. FIG. 4 is a diagram showing examples of changes in the appearance of a behavior command icon. Although in the examples shown in FIG. 4, the behavior command icon 45 shown in FIG. 3 is described, the appearances of the other behavior command icons 41 to 44 and 46 to 48 are also controlled similarly to the behavior command icon 45.

As shown in FIG. 4, a behavior command icon in a case where the command is in the usable state is displayed in a normal form in which the entirety of the behavior command icon can be viewed (see an upper field of FIG. 4). In a case where the command is specified and enters the unusable state, the game system 1 displays the behavior command icon indicating the command such that the entirety of the behavior command icon is in a changed form (see a middle field of FIG. 4). The changed form is a display form in which it is not possible to view the behavior command icon, or it is more difficult to view the behavior command icon than in the normal form. In FIG. 4, a portion of the behavior command icon displayed in the changed form is indicated by oblique lines. The game system 1 displays the behavior command icon so that a portion displayed in the normal form increases in accordance with the lapse of time since the command enters the unusable state (see a lower field of FIG. 4). The display of the behavior command icon is controlled so that the entirety of the behavior command icon is in the normal form at the timing when the command parameter reaches the above recovery time. Based on the above, the behavior command icon can notify the player of whether or not the command is in the usable state, and how much longer it takes the command to enter the usable state in a case where the command is in the unusable state.

The display form of the behavior command icon is not limited to the above. For example, in the examples shown in FIG. 4, the portion displayed in the normal form has a fan shape of which the central angle increases in accordance with the above lapse of time. In another exemplary embodiment, the display of the behavior command icon may be controlled so that the portion displayed in the normal form gradually widens from a lower portion of the behavior command icon to the upper side in accordance with the above lapse of time. In another exemplary embodiment, a gauge extending in accordance with the above lapse of time may be displayed along the circumference of the behavior command icon. Also based on these, the behavior command icon can notify the player of whether or not the command is in the usable state, and how much longer it takes the command to enter the usable state in a case where the command is in the unusable state.

Behavior command icons may be classified into several types in accordance with the contents of the behaviors associated with the commands or the effects of the behaviors, or may be displayed in colors corresponding to the classifications, or may be displayed with marks corresponding to classifications.

As described above, in the exemplary embodiment, a command in the unusable state is permitted to be used again by the command parameter reaching the recovery time. The command becoming able to be reused is generally termed “recasting”. The time until the recasting is termed a “recasting time” or the like. Here, in the exemplary embodiment, the game system 1 manages a recasting parameter and performs immediate recasting of the command under the condition of the consumption of the held recasting parameter in addition to conventional recasting based on the condition that the command parameter reaches the recovery time or the like, thereby permitting the command to be used again. This can make it easy to use the command at a desired timing in the battle scene. The use of the command based on the consumption of the recasting parameter is described below.

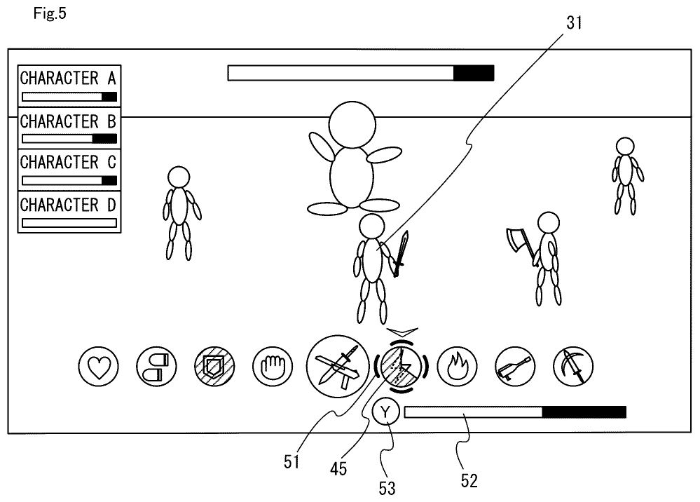

FIG. 5 is a diagram showing an example of a game image in the situation where a command can be used based on the consumption of the recasting parameter. In the situation shown in FIG. 5, the behavior command icon 45 is being selected using the cursor 51, and the behavior command icon 45 that is being selected is in a display form indicating that the command is in the unusable state.

As shown in FIGS. 3 and 5, the game image includes a recasting gauge 52 indicating the recasting parameter. In the exemplary embodiment, the recasting parameter is a parameter corresponding to the recasting time. A command parameter is set with respect to each command, whereas the recasting parameter is applied not with respect to each command, but in common to commands. In the example shown in FIG. 5, the value of the recasting parameter indicated by the recasting gauge 52 has a magnitude that enables the use of the command indicated by the behavior command icon 45.

In the situation shown in FIG. 5, since the command indicated by the behavior command icon 45 that is being selected is in the unusable state, even if the player provides the above first determination input, the command is not received, and the player character 31 does not take on the behavior associated with the command. Here, in the exemplary embodiment, in the situation shown in FIG. 5, the player can provide a second determination input for using a command in exchange for the consumption of the recasting parameter. For example, the second determination input is a button input different from a button input for the first determination input. As described above, in the exemplary embodiment, the player can indicate a command to be specified from among the plurality of behavior command icons 41 to 48 also by a direction input and a button input for the second determination input to the controller.

As shown in FIGS. 3 and 5, in the exemplary embodiment, the game images include a button image 53 representing a button for the second determination input. Here, the button for the second determination input is a Y-button provided in the right controller 4, and the button image 53 represents the Y-button. In the exemplary embodiment, the button image 53 is displayed in association with the recasting gauge 52. For example, the button image 53 is placed near the recasting gauge 52. The button image 53 can make it easy for the player to understand the method for the second determination input.

In a case where the second determination input is provided during the selection of a behavior command icon, the game system 1 receives the specifying of the command that is being selected under the condition that the time indicated by the recasting parameter is greater than or equal to the remaining time until the command parameter of the command that is being selected reaches the above recovery time. That is, in a case where the time indicated by the recasting parameter is greater than or equal to the above remaining time, the game system 1 determines that immediate recasting of the command that is being selected is performed, and causes the player character 31 to perform the behavior associated with the command that is being selected.

In the exemplary embodiment, in a case where the specifying of a command is received in accordance with the second determination input, the recasting parameter is consumed by the above remaining time. Specifically, the game system 1 updates the recasting parameter to a value indicating a time obtained by subtracting the above remaining time from the current value. For example, in the example shown in FIG. 5, in a case where the remaining time until the command parameter of the command indicated by the behavior command icon 45 reaches the above recovery time is 3 seconds, and the time indicated by the recasting parameter is 10 seconds, the recasting parameter is consumed by 3 seconds, and the recasting parameter after the consumption is 7 seconds. As described above, in the exemplary embodiment, in a case where a command is used based on the consumption of the recasting parameter, the recasting parameter is consumed by an amount corresponding to the shortfall until the command parameter at the current moment reaches the above recovery time. Based on this, the player can use a command by consuming the recasting parameter by an amount corresponding to the shortfall of the command parameter. For example, the player determines whether to consume the recasting parameter much and immediately use the command or to reduce the consumption of the recasting parameter by waiting to use the command, and then uses the command. Thus, it is possible to improve the level of strategy of the game in the battle scene.

In the exemplary embodiment, the recasting parameter is a value indicating a time that is of the same type as the command parameter. Here, in another exemplary embodiment, the recasting parameter does not need to be a value of the same type as the command parameter. For example, the recasting parameter may indicate the number of times the command can be used based on the consumption of the recasting parameter. For example, the consumption amount of the recasting parameter may be calculated as a value obtained by multiplying the shortfall of the command parameter by a predetermined coefficient. At this time, a condition for receiving the command in accordance with the second determination input is that the recasting parameter is greater than or equal to an amount obtained by multiplying the shortfall of the command parameter by the predetermined coefficient.

For example, the recasting parameter may be a parameter of which the value becomes smaller in accordance with the consumption of the recasting parameter as in the exemplary embodiment, or may be a parameter of which the value becomes greater in accordance with the consumption unlike the exemplary embodiment. It can be said that the recasting parameter of which the value becomes smaller in accordance with the consumption indicates an amount capable of making up for the shortfall of the command parameter. For example, the recasting parameter of which the value becomes greater in accordance with the consumption is set to 0 when a battle starts. When the recasting parameter is consumed, the recasting parameter is updated by adding an amount corresponding to the shortfall of the command parameter. It can be said that such a recasting parameter indicates an amount that has previously made up for the shortfall of the command parameter. To such a parameter, the upper limit value is set. In a case where a value obtained by subtracting the current recasting parameter from the upper limit value is greater than an amount corresponding to the shortfall of the command parameter, the game system 1 receives the command specified in accordance with the second determination input.

The recasting parameter does not need to be a parameter indicating time. For example, in a case where a command parameter is a parameter that is updated in accordance with the normal attack of the player character 31 as described above or a parameter that is updated in accordance with the passage of turns, the recasting parameter may not need to be a parameter indicating time, and for example, may be a value of the same type as the command parameter.

Also in a case where a command is used based on the consumption of the recasting parameter, the command is set to the unusable state after the command is used, similarly to a case where the command is used when the command is in the usable state. Also in a case where a command is used based on the consumption of the recasting parameter, the command parameter of the command is reset. If the command parameter is not reset in the above case, in the situation where the shortfall of the command parameter is small, the command can be continuously used many times only by consuming the recasting parameter by a small amount. In contrast, in the exemplary embodiment, the command parameter is reset in the above case, whereby it is possible to prevent the same command from being continuously used many times based on a small consumption amount in the above situation. In another exemplary embodiment, in the above case, the command parameter of the command may not be reset.

In a case where a command that is being selected is in the usable state, and in a case where the second determination input is provided, in the exemplary embodiment, the game system 1 executes a process similarly to a case where the first determination input is provided. That is, also in the above case, the command that is being selected is received, and the player character 31 takes on the behavior associated with the command. Here, for example, in the situation where the command parameter nearly reaches the above recovery time, a case is also possible where the player who attempts to specify the command that is being selected attempts to provide the second determination input, but at the time when the player actually provides the second determination input, the command parameter reaches the recovery time, and the command is in the usable state. If the second determination input cannot be received when a command that is being selected is in the usable state, in the above case, the command is not received even though the player provides the second determination input. Thus, the player may have discomfort about the operation. In contrast, in the exemplary embodiment, also in the above case, the command is used based on the second determination input. Thus, it is possible to reduce the possibility that the player has discomfort about the operation because the command is not used even though the second determination input is provided. Thus, it is possible to improve the operability of the game. In another exemplary embodiment, in a case where a command that is being selected is in the usable state, the game system 1 may not receive the second determination input.

In the exemplary embodiment, the behavior command icons 41 to 48 that, with respect to each command, indicate whether the command is in the usable state or the unusable state, and indicate the amounts of the command parameters and the recasting gauge 52 are displayed. Consequently, the state of a command that is currently being selected and the remaining amount of the recasting parameter are presented to the player. Thus, the player can confirm the state of the command, and with reference to the current value of the recasting parameter, can also determine whether or not to use the command in the unusable state based on the consumption of the recasting parameter.

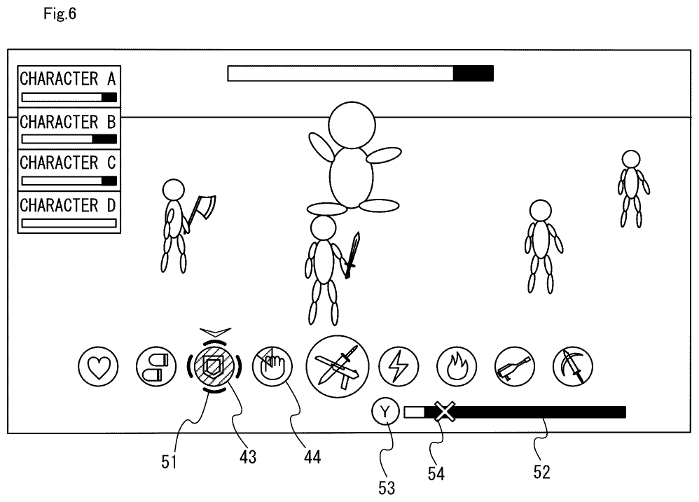

FIG. 6 is a diagram showing an example of a game image in the situation where a command cannot be used based on the consumption of the recasting parameter. In the situation shown in FIG. 6, the behavior command icon 43 is being selected using the cursor 51, and the behavior command icon 43 is in a display form indicating that the command is in the unusable state. In the situation shown in FIG. 6, the value of the recasting parameter indicated by the recasting gauge 52 is a value that does not enable the use of the command indicated by the behavior command icon 43, i.e., a value in which the command parameter corresponding to the behavior command icon 43 is smaller than the remaining time until the command parameter reaches the recovery time.

In the exemplary embodiment, in a case where a command that is being selected cannot be used based on the consumption of the recasting parameter, the game system 1 displays an unusable mark 54 indicating that the command cannot be used (see FIG. 6). For example, the unusable mark 54 is placed in a superimposed manner on the recasting gauge 52. The unusable mark 54 can notify the player of whether or not a command that is being selected can be used based on the consumption of the recasting parameter. In another exemplary embodiment, the unusable mark 54 may be displayed in accordance with the provision of the second determination input. Instead of displaying the unusable mark 54 as an image indicating whether a command can be used based on the consumption of the recasting parameter, the game system 1 may display the button image 53 in a case where the command can be used based on the consumption of the recasting parameter.

The display of the above unusable mark 54 is controlled based on a command that is being selected. For example, in a case where the cursor 51 is moved based on the above selection input in the situation shown in FIG. 6, and the behavior command icon 44 is being selected, the game system 1 erases the unusable mark 54 that has been displayed. In the situation shown in FIG. 6, the value of the recasting parameter indicated by the recasting gauge 52 is a value greater than the remaining time until the command parameter corresponding to the behavior command icon 44 reaches the recovery time. As described above, in the exemplary embodiment, the game system 1 displays the unusable mark 54 with respect to each command that is being selected, and therefore can notify the player of whether or not a command that is currently being selected can be used based on the consumption of the recasting parameter.

As described above, in the exemplary embodiment, a configuration is employed in which the game system 1 updates a command parameter in accordance with the lapse of time, and in a case where the recasting parameter is greater than or equal to the shortfall until the command parameter reaches the recovery time, the game system 1 receives the use of the command based on the consumption of the recasting parameter. In such a configuration, in accordance with whether or not the recasting parameter is less than the above shortfall, the above unusable mark 54 is displayed with respect to each command. Based on this, using the unusable mark 54, the player can confirm whether or not the command can be used based on the consumption of the recasting parameter at the current moment, and in a case where the command cannot be used, the player can select another command, thereby also confirming whether or not the other command can be used based on the consumption of the recasting parameter. For example, the player performs the game by considering whether to wait until a command that cannot be used at the current moment becomes usable and specify the command, or to specify another command that can be used at the current moment, and the like. Thus, it is possible to improve the level of strategy of the game.

In the exemplary embodiment, the recasting parameter is recovered after the battle scene ends. Specifically, in a case where the battle scene ends, the game system 1 sets the recasting parameter to the upper limit value, regardless of the value of the recasting parameter when the battle scene ends. The recovery amount of the recasting parameter after the battle scene ends is optional. In another exemplary embodiment, after the battle scene ends, the recasting parameter may be recovered by a predetermined amount set in advance. For example, the game system 1 may determine the recovery amount of the recasting parameter in accordance with the content of the battle, such as the number of enemy characters defeated during the battle. Based on the above, the player can use a command based on the consumption of the recasting parameter with respect to each single battle scene. This makes it easy for the player to consume the recasting parameter in each battle scene. Thus, it is possible to improve the convenience of the use of a command based on the consumption of the recasting parameter.

In another exemplary embodiment, the timing of the recovery of the recasting parameter is optional. The recasting parameter may be recovered at a timing other than the end of the battle scene. For example, in another exemplary embodiment, the game system 1 may set the recasting parameter to 0 at the start of the battle scene and update the recasting parameter to increase in accordance with the progress of the game in the battle scene while updating the recasting parameter to decrease in accordance with the use of a command based on the consumption of the recasting parameter.

In the exemplary embodiment, the game system 1 does not recover the recasting parameter during the battle scene. Based on this, it is possible to set a restriction on the use of a command that is performed based on the consumption of the recasting parameter in a single battle scene.

Based on the above, in the exemplary embodiment, for example, in a battle scene with a relatively weak enemy character, since the recasting parameter is recovered with respect to each battle scene, it is easy to end a battle in a short time by consuming the recasting parameter. For example, in a battle scene with a relatively strong enemy character such as an enemy boss character, since a restriction is set on the amount of the recasting parameter that can be consumed in a single battle scene, the player is required to advance a battle taking into account an appropriate timing when the recasting parameter should be consumed. Thus, it is possible to improve the level of strategy without the battle becoming too easy. Based on the above, according to the exemplary embodiment, the player can quickly advance the game by performing a battle without spending time on a battle scene at a low level of difficulty, and it is also possible to enjoy a game where the level of strategy is high in a battle scene at a high level of difficulty.

In the exemplary embodiment, the game system 1 increases the upper limit value of the recasting parameter in a predetermined scene in the game. For example, the above predetermined scene is a scene where the story of the game advances, a scene where a challenge set in the game is resolved, a scene where the player character 31 uses a predetermined item, or the like. Although the above example is an example where the above predetermined scene is a scene different from a battle scene, the above predetermined scene may be a scene that can occur during a battle scene. At this time, even if the upper limit value of the recasting parameter increases, the value of the recasting parameter itself does not increase. If the upper limit value of the recasting parameter increases, it is easy for the player to advance a battle. Thus, the player is given the opportunity to increase the upper limit value of the recasting parameter as described above, whereby it is possible to motivate the player to advance the game.

In the exemplary embodiment, the company characters 32 to 34 do not perform the behaviors of consuming the recasting parameter. However, in another exemplary embodiment, for example, in accordance with an instruction given by the player, the game system 1 may cause the company characters 32 to 34 to perform the behaviors of consuming the recasting parameter.

Next, an example is described where it is possible to advantageously advance the game in the battle scene by using a command based on the consumption of the recasting parameter.

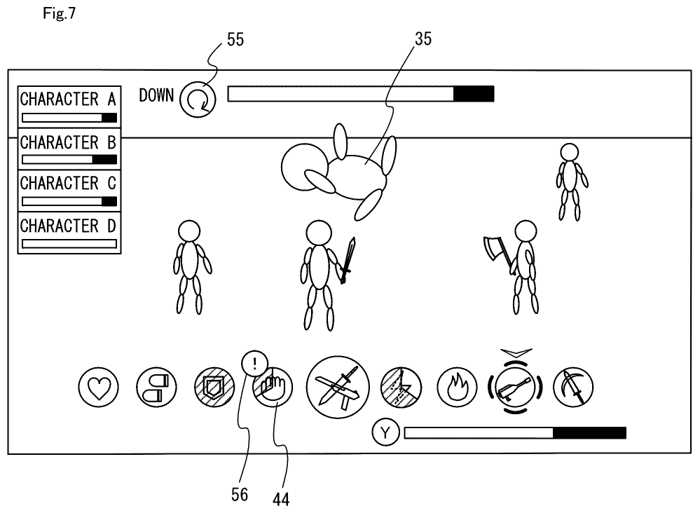

FIG. 7 is a diagram showing an example of a game image in the situation where the enemy character is down. In the exemplary embodiment, the enemy character 35 may enter the state where the enemy character 35 is off balance or the state where the enemy character 35 is down by an attack of the player character 31 or each of the company characters 32 to 34. For example, the enemy character 35 receives an attack of a particular type in the situation where the enemy character 35 is in the state where the enemy character 35 is off balance by receiving an attack, thereby entering the state where the enemy character 35 is down. After a certain time elapses since the enemy character 35 enters the state where the enemy character 35 is off balance or the state where the enemy character 35 is down, the enemy character 35 recovers from this state and returns to a normal state. In the example shown in FIG. 7, a state image 55 indicating that the state where the enemy character 35 is down is displayed. The state image 55 may include a gauge indicating the time until this state is recovered in addition to a mark indicating the state of the enemy character 35. The states that the enemy character 35 can enter are optional, and may include the state where the enemy character 35 is unconscious and the like in addition to the above state where the enemy character 35 is off balance and the state where the enemy character 35 is down.

In the exemplary embodiment, during a period in which the enemy character 35 is down, the effect of an attack of a particular attack behavior based on a particular behavior command is greater than during a period in which the enemy character 35 is in the normal state. For example, in the situation where the enemy character 35 is down, damage to be inflicted on the enemy character 35 by an attack becomes great, or an attack becomes likely to hit the enemy character 35. In the exemplary embodiment, during a period in which the enemy character 35 is down, even if the above particular command is in the unusable state, the player can use the command by consuming the recasting parameter. As described above, in the exemplary embodiment, it is easy to advantageously advance a battle by using a command based on the consumption of the recasting parameter.

In the exemplary embodiment, in a case where the enemy character 35 is in the state where the enemy character 35 is down, the game system 1 displays a notification mark 56 regarding a behavior command icon indicating the above particular attack behavior of which the effect becomes great in the state where the enemy character 35 is down (the behavior command icon 44 in the example of FIG. 7). This can notify the player of a command effective against the enemy character 35 in the state where the enemy character 35 is down.

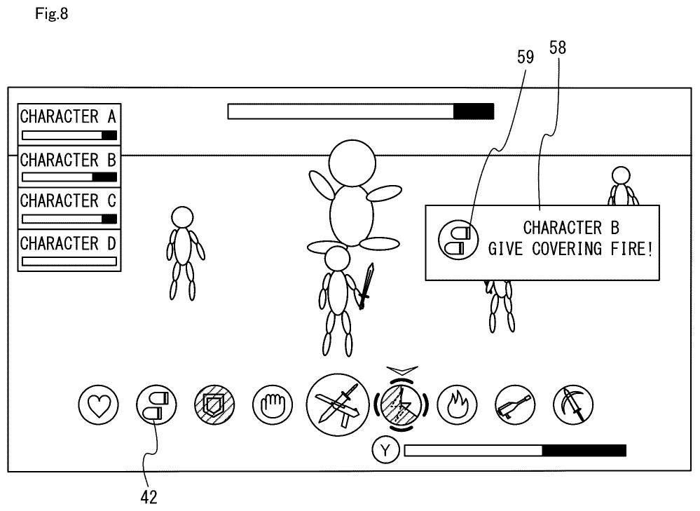

FIG. 8 is a diagram showing an example of a game image in the situation where a message from a company character is displayed. As shown in FIG. 8, in the exemplary embodiment, in a case where a predetermined message condition is satisfied in the battle scene, a message image 58 indicating a message from a company character is displayed. The above message condition is optional. For example, the message condition may be that the player character 31 takes on a particular behavior, or a parameter of the player character 31 reaches a predetermined value. For example, the message condition may be that the enemy character enters a predetermined state such as the state where the enemy character is partially destroyed, or the above state where the enemy character is down. In the exemplary embodiment, the message image 58 is displayed over a predetermined period.

The above message suggests a behavior that makes it easy to advantageously advance the battle by the player character 31 taking on the behavior at this time. In the example shown in FIG. 8, the message image 58 includes a message “give covering fire!” and includes an image 59 representing the behavior command icon 42 indicating a command regarding a shooting attack. In a case where commands that can be used by the player are classified into a plurality of types, the message image 58 may indicate a single particular command, or may indicate the type of a command. Also in the case shown in FIG. 8, similarly to FIG. 7, the notification mark 56 may be placed on the behavior command icon 42 indicated by the message image 58.

In a case where the player character 31 takes on the behavior corresponding to the command suggested by the message during a period in which the message image 58 is displayed, an advantage in the game is given to the player character 31. The advantage to be given is an advantage that is not given during a period in which the message image 58 is not displayed. The specific content of this advantage is optional. For example, the above advantage may be an increase in points for the player character 31 to use a special skill, or may be an increase in the effect of the behavior. In the exemplary embodiment, during a period in which the message image 58 is displayed, even if the command suggested by the message image 58 enters the unusable state, the player can use the command by consuming the recasting parameter. In the exemplary embodiment, in the situation shown in FIG. 7 and also in the situation shown in FIG. 8, it is easy to advantageously advance a battle by using a command based on the consumption of the recasting parameter.

In the exemplary embodiment, regarding an attack behavior based on a particular command, in a case where the player character 31 takes on the attack behavior on the enemy character 35 from behind, damage to be inflicted on the enemy character 35 is greater than in a case where the player character 31 takes on the attack behavior from a position other than behind. Thus, similarly to the examples shown in FIGS. 7 and 8, a period in which the player character 31 is located behind the enemy character 35 is also the situation where the game is advantageously advanced based on the particular command. In the exemplary embodiment, also in such a situation, even if the command is in the unusable state, the player can use the command by consuming the recasting parameter. During the above period, the above notification mark 56 may be placed on the behavior command icon indicating the above particular command.

As described above, in the exemplary embodiment, during a period in which a condition regarding the situation of a battle is satisfied, the game system 1 makes the effect of the behavior of the player character 31 corresponding to a predetermined command greater than during a period in which the condition is not satisfied. Here, it is difficult for the player to accurately predict the timing when a period in which the above condition is satisfied arrives. Thus, the situation is also possible where the command is used before such a timing arrives, and the command is in the unusable state at the time when the timing arrives. Regarding this, in the exemplary embodiment, even in such a situation, the player can use the command by consuming the recasting parameter. Thus, it is possible to improve the convenience of the use of a command.

### 3. Specific Example of Processing in Game System

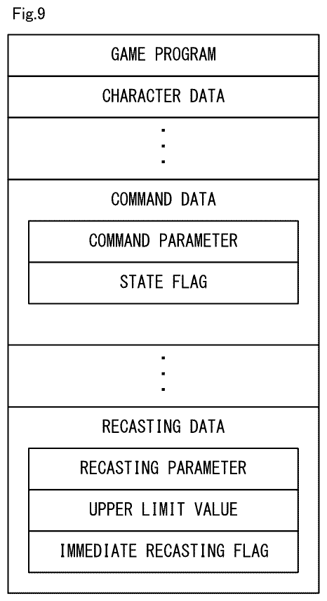

Next, with reference to FIGS. 9 to 12, a description is given of a specific example of the information processing in the game system 1.

FIG. 9 is a diagram showing examples of various pieces of data used for the information processing in the game system 1. The various pieces of data shown in FIG. 9 are stored in a storage medium (e.g., the flash memory 26, the DRAM 27, a memory card attached to the slot 29, and/or the like) accessible by the main body apparatus 2.

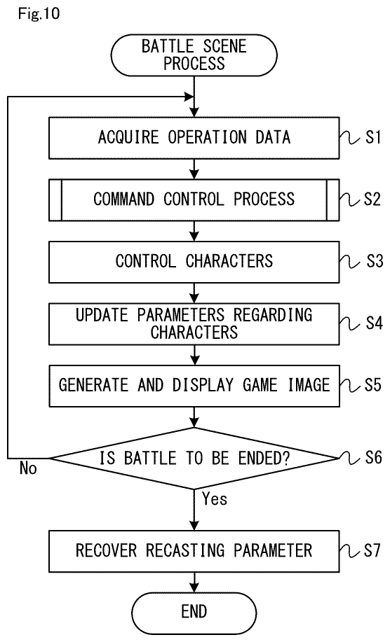

As shown in FIG. 9, the game system 1 stores a game program. The game program is a game program for executing game processing according to the exemplary embodiment (see FIGS. 10 to 12). The game system 1 stores character data, command data, and recasting data.

The character data is data regarding a character that appears in a battle scene. The game system 1 stores character data with respect to each character. In the exemplary embodiment, the character data includes data indicating parameters for the hit point and the like of the character, data indicating the state of the character, and the like.

The command data is data regarding a command that can be used in the battle scene by the player character 31. The game system 1 stores command data with respect to each command. In the exemplary embodiment, the command data includes data indicating a command parameter for the command, and data indicating a state flag indicating the state of the command. The state flag is a flag that is set to on in a case where the command is in the usable state, and is set to off in a case where the command is in the unusable state.

The recasting data is data regarding a recasting parameter. In the exemplary embodiment, the recasting data includes data indicating the recasting parameter, data indicating the upper limit value of the recasting parameter, and data indicating an immediate recasting flag. The immediate recasting flag is a flag indicating whether or not a command can be used based on the consumption of the recasting parameter.

FIG. 10 is a flow chart showing an example of the flow of a battle scene process executed by the game system 1. The battle scene process is game processing executed in a battle scene during the game. The battle scene process is started, for example, in accordance with the start of the battle scene during the execution of the above game program. In the exemplary embodiment, when the battle scene starts, a start command icon among a plurality of command icons is set to the state where the start command icon is being selected, and command data regarding each command is set to a content indicating the usable state. When the battle scene starts, the value of the recasting parameter indicated by the recasting data is the upper limit value.

In the exemplary embodiment, the description is given on the assumption that the processes of steps shown in FIGS. 10 to 12 are executed by the processor 21 of the main body apparatus 2 executing the above game program stored in the game system 1. In another exemplary embodiment, however, some of the processes of the above steps may be executed by a processor (e.g., a dedicated circuit or the like) different from the processor 21. In a case where the game system 1 can communicate with another information processing apparatus (e.g., a server), some of the processes of the steps shown in FIGS. 10 to 12 may be executed by the other information processing apparatus. The processes of all of the steps are merely illustrative. Thus, the processing order of the steps shown in FIGS. 10 to 12 may be changed, or another process may be performed in addition to (or instead of) the processes of all of the steps, so long as similar results are obtained.

The processor 21 executes the processes of the steps shown in FIGS. 10 to 12, using a memory (e.g., the DRAM 27). That is, the processor 21 stores information (in other words, data) obtained by each processing step in the memory. To use the information in the subsequent processing steps, the processor 21 reads the information from the memory and uses the read information.

In step S1 shown in FIG. 10, the processor 21 acquires operation data indicating an operation input provided by the player. That is, the processor 21 acquires operation data received from the controller via the controller communication section 25 and/or the terminals 22 and 23 and stores the operation data in a memory. After step S1, the process of step S2 is executed.

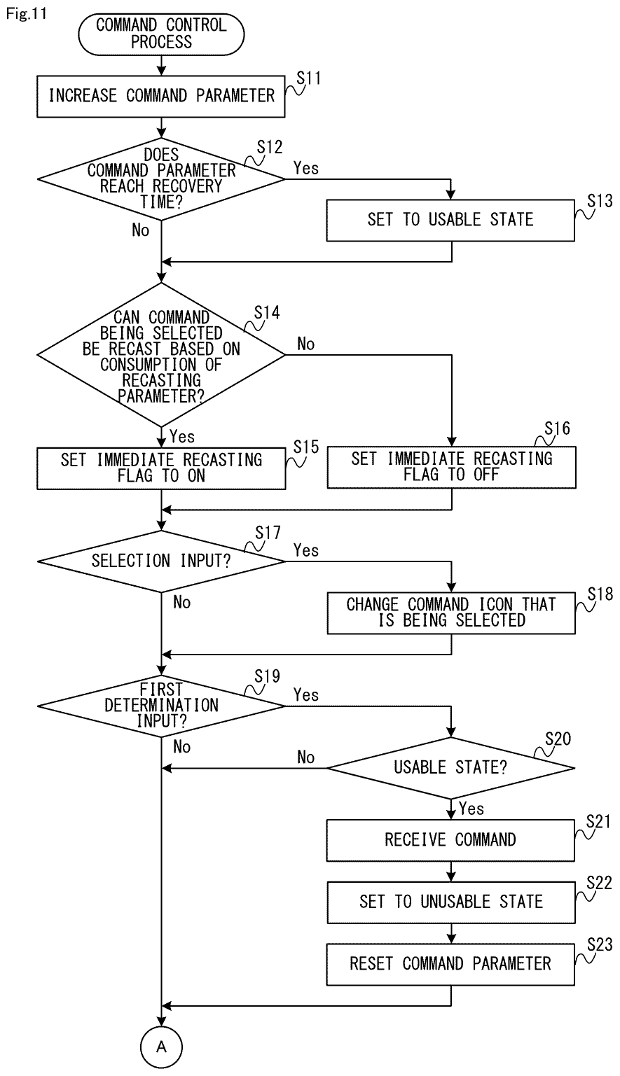

In step S2, the processor 21 executes a command control process for receiving a command under a certain condition in accordance with the operation input provided by the player. With reference to FIG. 11, the details of the command control process in step S2 are described.

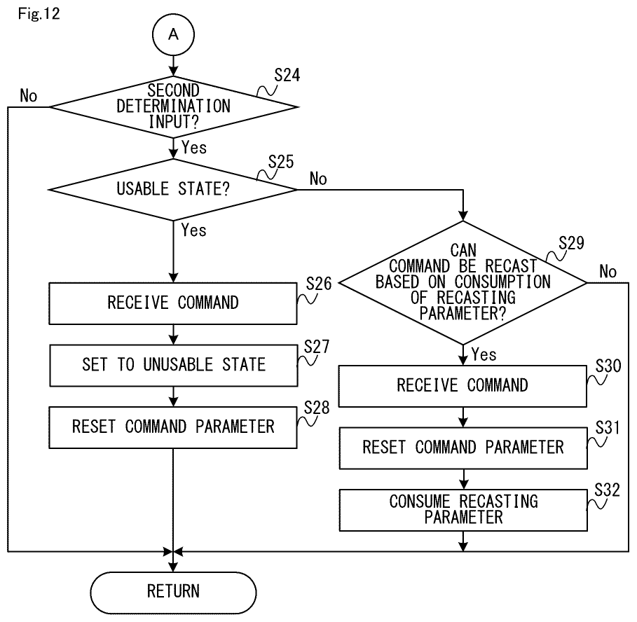

FIGS. 11 and 12 are sub-flow charts showing examples of the detailed flows of the command control process in step S2 shown in FIG. 10. In the command control process, first, in step S11, the processor 21 increases command parameters. Here, in the exemplary embodiment, the command control process shown in FIG. 12 is repeatedly executed once every frame time. Thus, the processor 21 increases the values of command parameters that do not reach the above recovery time among the command parameters regarding the commands by a value corresponding to one frame time. The processor 21 updates the command data stored in the memory to indicate the value after the above increase. After step S11, the process of step S12 is executed.

In step S12, the processor 21 determines whether or not there is a command parameter that reaches the recovery time among the command parameters increased in step S11. When the result of the determination in step S12 is positive, the process of step S13 is executed. On the other hand, when the result of the determination in step S12 is negative, the process of step S14 is executed.

In step S13, the processor 21 sets the command corresponding to the command parameter reaches the recovery time according to the determination in the process of step S12 to the usable state. Specifically, the processor 21 updates the command data stored in the memory so that the above state flag indicates on. After step S13, the process of step S14 is executed.

In step S14, the processor 21 determines whether or not the command that is being selected can be used based on the consumption of the recasting parameter. The determination in step S14 is made based on the value of the recasting parameter indicated by the recasting data stored in the memory and the value of the command parameter updated in the process of step S11. Specifically, the determination in step S14 is made based on whether or not the value of the recasting parameter is greater than equal to a value obtained by subtracting the value of the command parameter from the above recovery time (e.g., the remaining time until the command enters the usable state). When the result of the determination in step S14 is positive, the process of step S15 is executed. On the other hand, when the result of the determination in step S14 is negative, the process of step S16 is executed.

In step S15, the processor 21 sets the immediate recasting flag indicated by the recasting data to on. At this time, the immediate recasting flag indicates that the command that is being selected can be used based on the consumption of the recasting parameter. After step S15, the process of step S17 is executed.

In step S16, the processor 21 sets the immediate recasting flag indicated by the recasting data to off. At this time, the immediate recasting flag indicates that the command that is being selected cannot be used based on the consumption of the recasting parameter. In a case where the immediate recasting flag is set to off, in the process of step S5 described below, an unusable mark (see FIG. 6) indicating that the command cannot be used based on the consumption of the recasting parameter is displayed. After step S16, the process of step S17 is executed.

In step S17, the processor 21 determines whether or not a selection input for changing the command that is being selected is provided by the player. Specifically, based on the operation data acquired in step S1, the processor 21 determines whether or not a direction input for providing a selection input is provided. When the result of the determination in step S17 is positive, the process of step S18 is executed. On the other hand, when the result of the determination in step S17 is negative, the process of step S19 is executed.

In step S18, in accordance with the selection input, the processor 21 changes a command icon that is being selected among command icons that can be selected. Specifically, in accordance with a left or right direction input, the processor 21 sets a command icon placed one command icon left or right to the command icon that is currently being selected, as a new command icon that is being selected. After step S18, the process of step S19 is executed.

In step S19, the processor 21 determines whether or not the first determination input for specifying the command that is being selected is provided by the player. Specifically, based on the operation data acquired in step S1, the processor 21 determines whether or not a button input for the first determination input is provided. When the result of the determination in step S19 is positive, the process of step S20 is executed. On the other hand, when the result of the determination in step S19 is negative, the process of step S24 shown in FIG. 12 is executed.

In step S20, with reference to the command data stored in the memory, the processor 21 determines whether or not the command indicated by the command icon that is being selected is in the usable state. When the result of the determination in step S20 is positive, the process of step S21 is executed. On the other hand, when the result of the determination in step S20 is negative, the process of step S24 shown in FIG. 12 is executed.

In step S21, the processor 21 receives the specifying of the command indicated by the command icon that is being selected. At this time, in the process of step S3 described below, the player character is controlled to take on the behavior associated with the received command. After step S22, the process of step S23 is executed.

In step S22, the processor 21 sets the command indicated by the command icon that is being selected to the unusable state. Specifically, the processor 21 updates the command data stored in the memory so that the above state flag indicates off. After step S22, the process of step S23 is executed.

In step S23, the processor 21 resets the command parameter regarding the command indicated by the command icon that is being selected. Specifically, the processor 21 updates the command data stored in the memory so that the value of the command parameter regarding the command indicates 0. After step S23, the process of step S24 shown in FIG. 12 is executed.

In step S24 shown in FIG. 21, the processor 21 determines whether or not the second determination input for specifying the command that is being selected is provided by the player. Specifically, based on the operation data acquired in step S1, the processor 21 determines whether or not a button input for the second determination input is provided. When the result of the determination in step S24 is positive, the process of step S25 is executed. On the other hand, when the result of the determination in step S24 is negative, the processor 21 ends the command control process.

In step S25, with reference to the command data stored in the memory, the processor 21 determines whether or not the command indicated by the command icon that is being selected is in the usable state. When the result of the determination in step S25 is positive, the processes of steps S26 to S28 are executed. On the other hand, when the result of the determination in step S25 is negative, the process of step S29 is executed.

The processes of steps S26 to S28 are similar to the processes of the above steps S21 to S23. That is, in step S26, the command that is being selected is received. In step S27, the command is set to the unusable state. In step S28, the command parameter regarding the command is reset. After step S28, the processor 21 ends the command control process.

In step S29, the processor 21 determines whether or not the command indicated by the command icon that is being selected can be used based on the consumption of the recasting parameter. For example, the determination in step S29 is made based on whether or not the immediate recasting flag indicated by the recasting data stored in the memory is set to on. When the result of the determination in step S29 is positive, the processes of steps S30 to S32 are executed. On the other hand, when the result of the determination in step S29 is negative, the processor 21 ends the command control process.

The processes of steps S30 and S31 are similar to the processes of the above steps S21 and S23. That is, in step S30, the command that is being selected is received. In step S31, the command parameter regarding the command is reset. In the exemplary embodiment, in a case where the result of the determination in step S29 is positive, since the state flag indicated by the command data regarding the command that is being selected is off (i.e., a content indicating the unusable state), a process similar to that of step S22 is not executed. However, the process of managing the state of the command in a case where the command is used based on the consumption of the recasting parameter may be any process of setting the state after the command is used to the unusable state. The processor 21 may receive the command while the command data keeps indicating the unusable state, or may update the command data to indicate the usable state once and then update the command data again to indicate the unusable state. For example, in another exemplary embodiment, in a case where the result of the determination in step S29 is positive, the processor 21 may set the state flag to on before the process of step S30, and set the state flag to off again after the process of step S30.

In step S32, the processor 21 consumes the recasting parameter. In the exemplary embodiment, the recasting parameter is set to a value obtained by subtracting the remaining time until the command that is being selected enters the usable state from the current value. The processor 21 updates the recasting data stored in the memory to indicate the value after the above subtraction. After step S32, the processor 21 ends the command control process.

The description returns to FIG. 10. In step S3 after step S2, the processor 21 controls the characters that appear in a battle scene. The action of the player character is controlled based on an operation input provided by the player. In the exemplary embodiment, the player character moves in the game space in accordance with an operation input indicating a direction, or in a case where a command is received in the command control process in the above step S2, the player character is controlled to take on the behavior associated with the command. In the exemplary embodiment, the player character is also controlled in accordance with an algorithm set in the game program. In a case where a condition is satisfied, the player character makes the above normal attack. The actions of the company characters and the enemy character are controlled in accordance with an algorithm set in the game program. The process of step S3 may be a process similar to a conventional character control process.

In the exemplary embodiment, each character is controlled to perform an action corresponding to one frame in the process of step S3 performed once. The processor 21 may control each character to perform a single action such as an attack action or a recovery action over a plurality of frames. At this time, for example, during a period in the middle of the player character performing a certain action, the processor 21 may not receive an operation input or a command for causing the player character to perform another action. After step S3, the process of step S4 is executed.

In step S4, based on the result of the action controlled in the process of step S3, the processor 21 updates parameters regarding the characters. For example, the processor 21 decreases the parameter for the hit point of a character that has received an attack of another character, increases the hit point of a character that has received a recovery behavior, or updates the parameter indicating the state of a character under a certain condition. The processor 21 updates the character data stored in the memory to contents indicating the parameters after the updates. After step S4, the process of step S5 is executed.

In step S5, the processor 21 generates and displays a game image. In the exemplary embodiment, the game image to be generated includes an image representing the game space and UI images (see FIG. 3). For example, the processor 21 generates an image of the game space to include the player character 31 of which the action is controlled in the process of step S3 in the range of field of view. The processor 21 also generates the game image by superimposing the UI images on the image of the game space. In the exemplary embodiment, the UI images include the above player character-related image 36, the above enemy character-related image 37, the above command icons 40 to 48, the above message image 58, and the like (see FIG. 3). The player character-related image 36 and the enemy character-related image 37 are generated to indicate the parameters updated in the process of step S4. Images of the behavior command icons 41 to 48 are generated to be in display forms corresponding to the state of the command and the command parameter updated in the command control process in step S2 (see FIG. 4). An image of the cursor 51 is placed at the position where the cursor 51 points at the behavior command icon indicating the command that is being selected and is set in the command control process in step S2. An image of the recasting gauge 52 is generated to indicate the value of the recasting parameter updated in the command control process in step S2. In a case where the immediate recasting flag is set to off in the command control process in step S2, the unusable mark 54 is placed on the image of the recasting gauge 52. In a case where the above message condition is satisfied as the processing result in step S3 or S4, the above message image 58 is generated. A display device that displays the generated game image may be the display 12 of the main body apparatus 2, or may be another display device connected to the main body apparatus 2. After step S5, the process of step S6 is executed.

In step S6, the processor 21 determines whether or not to end the battle scene. For example, the processor 21 determines whether or not all the enemy characters are defeated or the player character and all the company characters are defeated. When the result of the determination in step S6 is negative, the process of step S1 is executed again. From this point onward, the series of processes of steps S1 to S6 is repeatedly executed until it is determined in step S6 that the battle scene is to be ended. On the other hand, when the result of the determination in step S6 is positive, the process of step S7 is executed.

In step S7, the processor 21 recovers the recasting parameter. In the exemplary embodiment, the processor 21 updates the recasting data stored in the memory so that the recasting parameter has a content indicating the upper limit value. After step S7, the processor 21 ends the battle scene process.

### 4. Operation and Effect and Variations of Exemplary Embodiment

As described above, in the exemplary embodiment, in a case where a command is in a usable state, the game system 1 causes a player character to perform a behavior associated with the command, and additionally, in a case where the command is in an unusable state, the game system 1 causes the player character to perform the behavior associated with the command based on the consumption of a recasting parameter. Consequently, in a game where a condition for using a command again is set, a player can also specify a command that does not satisfy the condition. Consequently, it is easy for the player to use a command at a desired timing during the game. Thus, it is possible to improve the convenience of the use of a command.

Although in the above exemplary embodiment, as an example of a battle scene, a description has been given of a battle scene where a game image representing the state where characters perform actions in a game space is displayed, the battle scene is not limited to this. For example, the battle scene may not be limited to a battle scene where a battle progresses in real time, and may be a battle scene where a battle progresses in a turn-based manner. A game image representing a battle scene may not be limited to a game image including an image of a player character and an enemy character, and for example, may be a game image that does not include an image of a player character and includes only an image of an enemy character, or may be a game image that does not include an image of a character and displays the situation of a battle in text.

In the above exemplary embodiment, when a process is executed by a certain information processing apparatus using data (including a program), a part of data necessary for the process may be transmitted from another information processing apparatus different from the certain information processing apparatus. At this time, the certain information processing apparatus may execute the above process using the data received from the other information processing apparatus and data stored in the certain information processing apparatus.

In another exemplary embodiment, an information processing system may not include a part of the configuration in the above exemplary embodiment, and may not execute a part of the process executed in the above exemplary embodiment. For example, to obtain a particular result of a part of the above exemplary embodiment, the information processing system may only need to include a configuration for obtaining the result and execute a process for obtaining the result, and may not include another configuration, and may not execute another process.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable medium having stored therein instructions that, when executed, cause one or more processors of an information processing apparatus to execute information processing comprising:
in a battle scene between a player character and an enemy character in a game,
in a case where any of commands of a plurality of types is specified by a first instruction based on an operation input, and a state of the specified command is a usable state between the usable state and an unusable state,
causing the player character to perform a behavior associated with the command;
causing the specified command to transition to the unusable state; and
resetting a first parameter associated with the specified command among first parameters set for the respective commands;
in a case where the first parameter satisfies a first condition, causing the command associated with the first parameter to transition to the usable state, wherein the first parameter regarding each of the commands in the unusable state is updated in accordance with progress of a game; and
in a case where the command in the unusable state is specified by a second instruction based on an operation input, and a second parameter can be consumed;
consuming the second parameter;
causing the player character to perform the behavior associated with the command;
setting the specified command to the unusable state; and
resetting the first parameter associated with the specified command.

2. The one or more non-transitory computer-readable medium according to claim 1, wherein
the information processing comprises
updating the first parameter regarding each of the commands in the unusable state in accordance with a lapse of time as the progress of the game.

3. The one or more non-transitory computer-readable medium according to claim 2, wherein
the first condition is satisfied by a lapse of time having a length set with respect to each of the commands since the first parameter is reset.

4. The one or more non-transitory computer-readable medium according to claim 1, wherein
the information processing comprises
in a case where the command in the unusable state is specified by the second instruction, and the second parameter that remains is greater than or equal to a decrease amount corresponding to a shortfall until the first parameter regarding the specified command at this time satisfies the first condition, decreasing the second parameter by the decrease amount, thereby consuming the second parameter.

5. The one or more non-transitory computer-readable medium according to claim 1, wherein
the information processing comprises
recovering the second parameter after the battle scene ends.

6. The one or more non-transitory computer-readable medium according to claim 5, wherein
during the battle scene, the second parameter is not recovered.

7. The one or more non-transitory computer-readable medium according to claim 1, wherein
the second parameter is not recovered during the battle scene, and
the information processing comprises:
recovering the second parameter to an upper limit value after the battle scene ends; and
increasing the upper limit value of the second parameter in a first scene in the game.

8. The one or more non-transitory computer-readable medium according to claim 1, wherein
the information processing further comprises
displaying an icon indicating, with respect to each of the commands, whether the command is in the usable state or the unusable state, and the first parameter in the unusable state, and a gauge indicating the second parameter.

9. The one or more non-transitory computer-readable medium according to claim 8, wherein
the first instruction is an instruction to select the command based on a direction input and determine a command that is being selected in accordance with a first button input, thereby specifying the determined command,
the second instruction is an instruction to select the command based on the direction input and determine a command that is being selected in accordance with a second button input, thereby specifying the determined command, and
the information processing comprises
with respect to each of the commands that are being selected, displaying an indicator indicating whether or not the second parameter can be consumed regarding the command.

10. The one or more non-transitory computer-readable medium according to claim 1, wherein
during a period in which a second condition regarding a situation of a battle is satisfied, an effect of the behavior corresponding to the first command among the commands of the plurality of types is greater than during a period in which the second condition is not satisfied.

11. An information processing system comprising:
one or more processors that are configured to execute information processing comprising:
in a battle scene between a player character and an enemy character in a game,
in a case where any of commands of a plurality of types is specified by a first instruction based on an operation input, and a state of the specified command is a usable state between the usable state and an unusable state,
causing the player character to perform a behavior associated with the command;
causing the specified command to transition to the unusable state; and
resetting a first parameter associated with the specified command among first parameters set for the respective commands;
in a case where the first parameter satisfies a first condition, causing the command associated with the first parameter to transition to the usable state, wherein the first parameter regarding each of the commands in the unusable state is updated in accordance with progress of a game; and
in a case where the command in the unusable state is specified by a second instruction based on an operation input, and a second parameter can be consumed;
consuming the second parameter;
causing the player character to perform the behavior associated with the command;
setting the specified command to the unusable state; and
resetting the first parameter associated with the specified command.

12. The information processing system according to claim 11, wherein
the information processing comprises
updating the first parameter regarding each of the commands in the unusable state in accordance with a lapse of time as the progress of the game.

13. The information processing system according to claim 12, wherein
the first condition is satisfied by a lapse of time having a length set with respect to each of the commands since the first parameter is reset.

14. The information processing system according to claim 11, wherein
the information processing comprises
in a case where the command in the unusable state is specified by the second instruction, and the second parameter that remains is greater than or equal to a decrease amount corresponding to a shortfall until the first parameter regarding the specified command at this time satisfies the first condition, decreasing the second parameter by the decrease amount, thereby consuming the second parameter.

15. The information processing system according to claim 11, wherein
the information processing comprises
recovering the second parameter after the battle scene ends.

16. The information processing system according to claim 15, wherein
during the battle scene, the second parameter is not recovered.

17. The information processing system according to claim 11, wherein
the second parameter is not recovered during the battle scene, and
the information processing comprises:
recovering the second parameter to an upper limit value after the battle scene ends; and
increasing the upper limit value of the second parameter in a first scene in the game.

18. The information processing system according to claim 11, wherein
the information processing further comprises
displaying an icon indicating, with respect to each of the commands, whether the command is in the usable state or the unusable state, and the first parameter in the unusable state, and a gauge indicating the second parameter.

19. The information processing system according to claim 18, wherein
the first instruction is an instruction to select the command based on a direction input and determine a command that is being selected in accordance with a first button input, thereby specifying the determined command,
the second instruction is an instruction to select the command based on the direction input and determine a command that is being selected in accordance with a second button input, thereby specifying the determined command, and
the information processing comprises
with respect to each of the commands that are being selected, displaying an indicator indicating whether or not the second parameter can be consumed regarding the command.

20. The information processing system according to claim 11, wherein
during a period in which a second condition regarding a situation of a battle is satisfied, an effect of the behavior corresponding to the first command among the commands of the plurality of types is greater than during a period in which the second condition is not satisfied.

21. A game processing method performed on an information processing system, the game processing method comprising:
in a battle scene between a player character and an enemy character in a game,
in a case where any of commands of a plurality of types is specified by a first instruction based on an operation input, and a state of the specified command is a usable state between the usable state and an unusable state,
causing the player character to perform a behavior associated with the command;
causing the specified command to transition to the unusable state; and
resetting a first parameter associated with the specified command among first parameters set for the respective commands;
in a case where the first parameter satisfies a first condition, causing the command associated with the first parameter to transition to the usable state, wherein the first parameter regarding each of the commands in the unusable state is updated in accordance with progress of a game; and
in a case where the command in the unusable state is specified by a second instruction based on an operation input, and a second parameter can be consumed;
consuming the second parameter;
causing the player character to perform the behavior associated with the command;
setting the specified command to the unusable state; and
resetting the first parameter associated with the specified command.

22. The game processing method according to claim 21, comprises
updating the first parameter regarding each of the commands in the unusable state in accordance with a lapse of time as the progress of the game.

23. The game processing method according to claim 22, wherein
the first condition is satisfied by a lapse of time having a length set with respect to each of the commands since the first parameter is reset.

24. The game processing method according to claim 21, comprises
in a case where the command in the unusable state is specified by the second instruction, and the second parameter that remains is greater than or equal to a decrease amount corresponding to a shortfall until the first parameter regarding the specified command at this time satisfies the first condition, decreasing the second parameter by the decrease amount, thereby consuming the second parameter.

25. The game processing method according to claim 21, comprises
recovering the second parameter after the battle scene ends.

26. The game processing method according to claim 25, wherein
during the battle scene, the second parameter is not recovered.

27. The game processing method according to claim 21, wherein
the second parameter is not recovered during the battle scene, and
the information processing comprises:
recovering the second parameter to an upper limit value after the battle scene ends; and
increasing the upper limit value of the second parameter in a first scene in the game.

28. The game processing method according to claim 21, comprises
displaying an icon indicating, with respect to each of the commands, whether the command is in the usable state or the unusable state, and the first parameter in the unusable state, and a gauge indicating the second parameter.

29. The game processing method according to claim 28, wherein
the first instruction is an instruction to select the command based on a direction input and determine a command that is being selected in accordance with a first button input, thereby specifying the determined command,
the second instruction is an instruction to select the command based on the direction input and determine a command that is being selected in accordance with a second button input, thereby specifying the determined command, and
the information processing comprises
with respect to each of the commands that are being selected, displaying an indicator indicating whether or not the second parameter can be consumed regarding the command.

30. The game processing method according to claim 21, wherein
during a period in which a second condition regarding a situation of a battle is satisfied, an effect of the behavior corresponding to the first command among the commands of the plurality of types is greater than during a period in which the second condition is not satisfied.
